(19) United States
(12) Patent Application Publication
(10) Pub. No.: US 2024/0053740 A1
(43) Pub. Date: Feb. 15, 2024

(54) DEGRADATION-BASED RELIABILITY ANALYSIS SYSTEM AND METHOD UTILIZING A MICROSTRUCTURE IMAGE

(71) Applicant: Wayne State University, Detroit, MI (US)

(72) Inventors: Qingyu Yang, Canton, MI (US); Xin Wu, Canton, MI (US)

(21) Appl. No.: 18/232,562

(22) Filed: Aug. 10, 2023

Related U.S. Application Data
(60) Provisional application No. 63/397,490, filed on Aug. 12, 2022.

(51) Int. Cl. G05B 23/02

(52) U.S. Cl. CPC G05B 23/0283; G05B 23/0243

(57) ABSTRACT

A degradation-based reliability analysis method may include capturing, via an imager, a microstructure image of a material and transmitting the microstructure image to a computer. The method may also include extracting microstructure image information from the microstructure image to quantitatively characterize a microstructure of the material via processing the microstructure image with the computer. The method may further include incorporating, via the computer, the microstructure image information into a nonlinear degradation model. Additionally, the method may include making, via the computer, at least one of a determination and a prediction regarding the material based on the nonlinear degradation model.

### CROSS-REFERENCE TO RELATED APPLICATIONS

This application claims priority to U.S. Provisional Patent Application No. 63/397,490, filed Aug. 12, 2022, the contents of which is hereby incorporated by reference in its entirety.

### TECHNICAL FIELD

This disclosure relates generally to a system (e.g., a reliability analysis system) for degradation-based reliability analysis of an object and/or a material and a method of conducting degradation-based reliability analysis utilizing a nonlinear degradation model.

### BACKGROUND

Degradation-based reliability analysis is a key aspect in reliability evaluation, prediction, and prognosis of critical or important systems. Degradation-based reliability analysis is relevant to a variety of different technological fields and has a variety of different applications, such as accelerated degradation testing, health state evaluation, remaining useful life prediction, and maintenance planning. In degradation-based reliability analysis, the performance of a system is described by one or more performance indicators and the system fails when the degradation processes reaches a pre-defined failure threshold. Compared to failure time data, degradation data often encompasses more useful information to evaluate reliability and remaining useful life. Examples of degradation data include the deterioration of LED brightness and performance over time, the crack increment of mechanical structures, and the fatigue propagation of material, among others.

### SUMMARY

A degradation-based reliability analysis method may include capturing, via an imager, a microstructure image of a material and transmitting the microstructure image to a computer. The method may also include extracting microstructure image information from the microstructure image to quantitatively characterize a microstructure of the material via processing the microstructure image with the computer. The method may further include incorporating, via the computer, the microstructure image information into a nonlinear degradation model. Additionally, the method may include making, via the computer, at least one of a determination and a prediction regarding the material based on the nonlinear degradation model.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and are not restricted to the precise form and configuration shown in the drawings or disclosed in the following detailed description. Exemplary illustrations are described in detail by referring to the drawings as follows:

FIG. 1 is a schematic view generally illustrating a system for degradation-based reliability analysis of an object and/or a material based on a microstructure image according to the disclosure;

FIG. 2 illustrates a method of conducting degradation-based reliability analysis utilizing a nonlinear degradation model based on a microstructure image according to the disclosure; and

FIG. 3 illustrates an EM method for estimating the parameters of a nonlinear degradation model according to the disclosure.

### DETAILED DESCRIPTION

In the drawings, where like numerals and characters indicate like or corresponding parts throughout the several views, exemplary illustrates are shown in detail. The various features of the exemplary approaches illustrated and described with reference to any one of the figures may be combined with features illustrated in one or more other figures, as it will be understood that alternative illustrations that may not be explicitly illustrated or described may be able to be produced. The combinations of features illustrated provide representative approaches for typical applications. However, various combinations and modifications of the features consistent with the teachings of the present disclosure may be desired for particular applications or implementations.

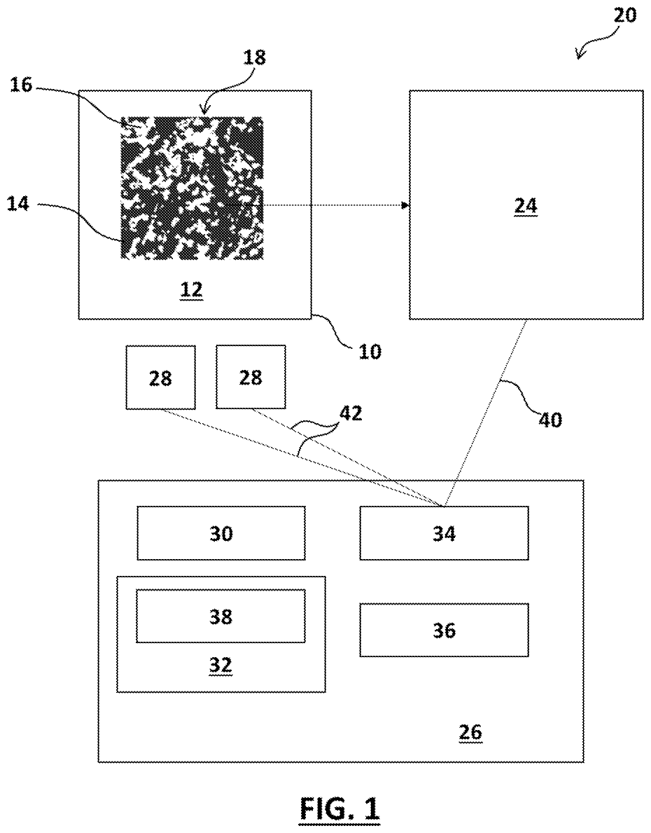

FIG. 1 generally illustrates a system 20 (e.g., a reliability analysis system 20) for degradation-based reliability analysis of a material 12 and/or an object 10 composed thereof. As explained in detail below, the system 20 is configured to obtain and/or make one or more determinations and/or predictions about a material 12 based on at least one microstructure image of the material 12 via executing a degradation-based reliability analysis method 100 utilizing a nonlinear degradation model. For example, the system 20 may be utilized to predict an expected failure time and/or an expected useful lifetime of the material 12 (e.g., the material 12 is most likely to fail at five years and, thus, has an expected useful lifetime of five years). The system 20 may also be effectively used to predict the failure probability of the material 12 at a given time (e.g., at three years, there is a 30% chance that the material 12 will have failed due to degradation and a 70% chance that it will not have failed due to degradation). In addition, the system 20 may be utilized to predict an expected degradation level of the material 12 at a given time (e.g., at three years, there is a 20% chance of that the material 12 has experienced less than 10% degradation, a 5% chance of 10% degradation, and a 75% chance of greater than 10% degradation).

The system 20 may be utilized to analyze a variety of material 12 and/or objects 10. In at least some instances, the object 10 may include and/or may be composed of the material 12. The object 10 may be essentially any physical body (e.g., a bar, rod, beam, member) used in connection with a variety of different industries (e.g., automotive, aerospace, construction). For example, the object 10 may be a developmental component that is being considered for production and the system 20 may be utilized to evaluate the suitability of the developmental component for one or more projects. As another example, the object 10 may be a recently manufactured and/or unused component and the system 20 may be utilized for quality control purposes. Additionally, in other examples, the object 10 may be an old, used, and/or at least partially degraded component (e.g., that has failed for non-degradation purposes; that was scrapped to make way for a new construction) and the system 20 may be utilized to make predictions about other components currently being used in comparable manners, environments, and/or situations.

The material 12 may be essentially any type of multi-phase metal used in connection with a variety of different industries (e.g., automotive, aerospace, construction). Conceivably, the material 12 could alternatively be one or more non-metal materials (e.g., a plastic, ceramic, composite). The material 12 in the illustrative example of FIG. 1 includes two material phases 14, 16 with different material properties (e.g., hardness, strength, ductility) and is therefore considered a dual-phase material. Nevertheless, the material 12 may conceivably include other numbers and/or combinations of material phases. In the microstructure image 18 of the material 12 illustrated in FIG. 1, a first material phase 14 of the material 12 is represented by the black regions and a second material phase 16 is represented by the white regions. The spatial distribution of the two material phases 14, 16 throughout the microstructure image 18 can significantly influence the properties (e.g., mechanical properties) and degradation (e.g., wear, deformation, crack growth) of the material 12 and/or object 10, which contribute to failure. The microstructure of the material 12 therefore encompasses abundant information useful in accurate degradation-based reliability analysis.

In the illustrative example of FIG. 1, the object 10 is an elongated member of a vehicle frame and is composed of the material 12. The material 12 is a dual-phase advanced high strength steel (AHSS), which is commonly used in automotive applications. The AHSS includes a martensite phase and a ferrite phase, but may conceivably include other numbers and combinations of material phases. The martensite phase is the first material phase 14 and is represented by the black regions in the microstructure image 18 of FIG. 1. The ferrite phase is the second material phase 16 and is represented by the white regions in the microstructure image 18 of FIG. 1. The microstructure image 18 has a ×1000 magnification and shows a 100 μm by 100 μm area of the material 12 of the object 10.

The system 20 includes an imager 24 and a computer 26. Optionally, the system 20 may include one or more sensors 28. The one or more sensors 28 includes at least one environmental sensor configured to collect environmental data (e.g., temperature, structure load, and/or humidity) in connection with the object 10 and/or material 12. In other examples, the system 20 does not include one or more sensors 28 nor an environmental sensor.

The imager 24 is communicatively connected to the computer 26 (e.g., wirelessly and/or wired). The imager 24 is configured to capture microstructure information of the object 10 and/or the material 12, such as by capturing a microstructure image 18 of the object 10 and/or material 12. The microstructure image 18 may show an area of an exposed face/surface of the material 12 and/or object 10, which area may also be etched to enhance visibility of the material phases 14, 16. The imager 24 is also configured to transmit the captured microstructure information (e.g., the microstructure image 18) to the computer 26. The imager 24 is an electric microscope in the illustrative example, but may alternatively be another device capable of capturing the microstructure image 18.

The computer 26 includes a processor 30, a memory 32, a transceiver 34, and a user interface 36. The processor 30 includes a hardware processor that executes one or more programs 38 to provide any or all of the operations described herein and that are stored as instructions on the memory 32. The transceiver 34 is communicatively connected to the imager 24 via a connection 40 (e.g., wireless and/or wired) and to the one more sensors 28 via a connection 42 (e.g., wireless and/or wired). The computer 26 may include a desktop, a laptop, a tablet computer, a mobile device, and/or a cellular device, among others.

The computer 26 is configured to receive microstructure information (e.g., one or more microstructure images 18) from the imager 26 and/or environmental data from the one or more sensors 28. The computer 26 is configured to process the microstructure images 18 and/or the environmental data. The computer 26 is configured to obtain and/or make one or more determinations and/or predictions about the material 12 and/or object 10 based on at least one microstructure image 18 via executing a degradation-based reliability analysis method 100 utilizing a nonlinear degradation model. Optionally, the computer 26 is also configured to consider and/or account for environmental data (e.g., obtained via one or more sensors 28) when obtaining and/or making the one or more determinations and/or predictions about the material 12 and/or object 10.

The newly developed nonlinear degradation model is an extension of the existing stochastic Inverse Gaussian degradation process that integrates material microstructure image covariates. The nonlinear degradation model can effectively model degradation processes or functions having a nonlinear trend and, therefore, is referred to as a nonlinear degradation model. The nonlinear degradation model is shown below as Equation (1).

yᵢⱼ˜IG(μᵢΛ(tᵢⱼ),ηΛ²(tᵢⱼ))

μᵢ⁻¹=μ₀+ψ(Iᵢ)+εᵢ (1)
y denotes degradation level.
t denotes time.
yᵢⱼ is the degradation level of the i^{th} sample at sampling time tᵢⱼ for i=1, 2, . . . , n and j=1, 2, . . . , mᵢ. The degradation level yᵢⱼ is assumed to follow an IG process with parameters μᵢ and η.
n is the number of degradation path samples.
mᵢ is the number of the degradation measurements of the i^{th} sample.
Λ(t) is a monotone increasing function of time t that starts from 0.
μᵢ⁻¹ is a random variable for i=1, 2, . . . , n.
μ₀ is the baseline parameter.
Iᵢ represents the microstructure image information of the i^{th} sample and is considered a microstructure image covariate. As explained further below, the microstructure image information Iᵢ is extracted from the microstructure image 18 (e.g., via capturing the statistical dependency among pixels in the microstructure image 18, such as by applying a parametric model, a semiparametric model, and/or a nonparametric model).
ψ( ) is a link function that links the random variable μᵢ⁻¹ to the microstructure image information Iᵢ. The random variable μᵢ⁻¹ is linked to the microstructure image information Iᵢ by the link function ψ( ) to integrate the microstructure image information Iᵢ. By using the link function ψ( ), the multi-dimensional microstructure image information Iᵢ can be transformed into model parameters that effectively capture the microstructure of the object 10 and/or material 12 depicted in the microstructure image 18.

εᵢ is the error term. Because IG(μᵢΛ(tᵢⱼ),ηΛ²(tᵢⱼ)) is an Inverse Gaussian process, μᵢ can only have a positive value. Thus, ε₁ is assumed to follow a truncated normal distribution with parameters (0, σ²) and εᵢ is bounded in the interval (−μ₀−ψ(Iᵢ)+∞).

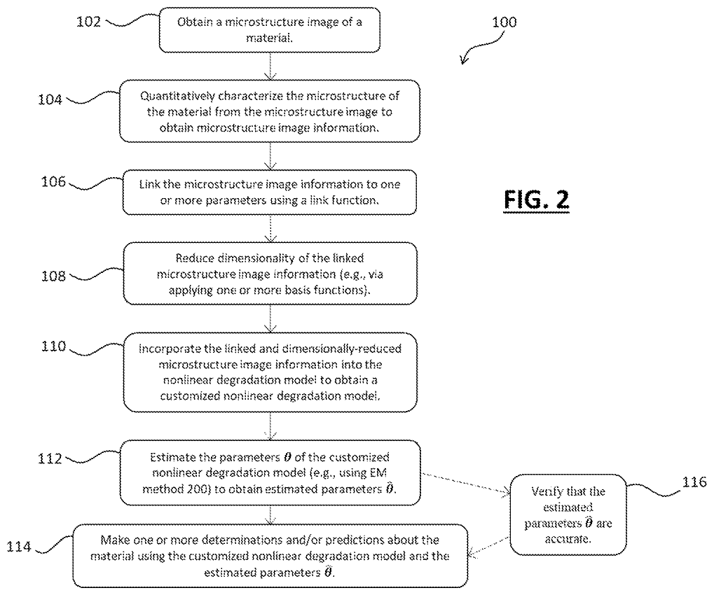

An exemplary method 100 of degradation-based reliability analysis utilizing the nonlinear degradation model is depicted in FIG. 2. The method 100 may include one or more steps as described below, which may be performed with the disclosed system 20.

First, at step 102, the method 100 includes obtaining at least one microstructure image 18 of the material 12 and/or the object 10 that is the subject of the degradation-based reliability analysis. Obtaining the microstructure image 18 includes altering, breaking, and/or fracturing the object 10 and/or material 12 to expose its interior microstructure. The imager 24 is then used to capture one or more images 18 of the microstructure of the object 10 and/or material 12. The microstructure images 18 are captured from an exposed face and/or surface of the object 10 and/or material 12 that was produced by altering, breaking, and/or fracturing the object 10 and/or material 12. Optionally, at least a portion of the exposed face and/or surface is etched prior to capturing the microstructure image 18 to enhance visibility of the different material phases 14, 16 present in the microstructure of the object 10 and/or material 12. Alternatively, the microstructure image 18 of the object 10 and/or material 12 may be obtained via one or more other known processes. The imager 24 then transmits the captured microstructure image 18 to the computer 26.

At step 104, the method 100 includes quantitatively characterizing the microstructure of the material 12 and/or object 10 via extracting microstructure image information Iᵢ from the microstructure image 18 captured during step 102. Extracting microstructure image information Iᵢ may include capturing the statistical dependency among pixels in the microstructure image 18, such as by applying an extraction model. In the illustrative method 100, the extraction model is a nonparametric model called the two-point correlation function process. The two-point correlation function process is applied to the captured microstructure image 18 to extract the microstructure image information Iᵢ therefrom (e.g., via extracting topology information from stochastic spatial data). Conceivably, one or more other extraction models (e.g., a parametric model, a semiparametric model, a nonparametric model) may be applied to the captured microstructure image 18 to extract the microstructure image information Iᵢ therefrom.

Simply put, the two-point correlation function process involves calculating the probability that two randomly chosen points in the captured microstructure image fall within the same material phase (e.g., the probability that both points fall within the first material phase 14/black region of the microstructure image 18 or the second material phase 16/white region of the microstructure image 18). The two-point correlation function process is able to characterize statistical properties up to the second-order of the microstructure image 18. The two-point correlation function process is also invariant under rotation of the spatial coordinates for statistically isotropic media. For heterogeneous materials, such as the material 12 being analyzed in the exemplary method 100, a two-point correlation function of each phase 14, 16 can be uniquely determined by the other (i.e., a first two-point correlation function of the first material phase 14 can be used to determine a second two-point correlation function of the second material phase 16 and visa versa). The two-point correlation function of either material phase 14, 16, denoted by Xᵢ(r), may therefore be utilized in the method 100. As such, applying the two-point correlation function process to the material microstructure image includes calculating the two-point correlation function Xᵢ(r) using Equation (2) shown below. The calculated two-point correlation function Xᵢ(r) represents the microstructure image information Iᵢ extracted from the microstructure image 18 as a function and/or curve.

$${I}_{i} = {X}_{i} ( r ) = \frac{{\sum }_{\sqrt{{k}^{2} + {l}^{2}} = r} [ {\sum }_{i = 1}^{d} {\sum }_{j = 1}^{d} {P}_{( i , j )} {P}_{( i + k , j + l )} ]}{{d}^{2}} \qquad ( 2 )$$

d is the dimension of the microstructure image 18, which has a size of d×d (e.g., 100 μm×100 μm). P₍ᵢ_{₁}_{,j}_{₁}₎ and P₍ᵢ_{₂}_{,j}_{₂}₎ are the two points in the microstructure image 18 where (i₁,j₁) and (i₂,j₂) are the image coordinates of the two points P₍ᵢ_{₁}_{,j}_{₁}₎ and P₍ᵢ_{₂}_{,j}_{₂}₎, respectively. r is the distance between the two points P₍ᵢ_{₁}_{,j}_{₁}₎ and P₍ᵢ_{₂}_{,j}_{₂}₎.

Step 104 further includes, without loss of generality, normalizing the distance r∈[0,d) is normalized to r∈[0,1).

Optionally, to ensure the identifiability of the model distribution parameters, the centered two-point correlation function denoted Xᵢ′(r) may be used instead of the standard two-point correlation function Xᵢ(r). As such, step 104 includes calculating the centered two-point correlation function Xᵢ′(r) using Equation (3).

Xᵢ′(r)=Xᵢ(r)−E[Xᵢ(r)] (3)

Applying the two-point correlation function process to the microstructure image 18 during step 104 as described above may be carried out with one or more programs and/or algorithms stored on and executed by the computer 26. The computer 26 may receive the captured microstructure image 18 from the imager 24 and process the captured microstructure image 18 when applying the two-point correlation function process. Application of the two-point correlation function process is generally known, as evidenced by “Jiao Y, Stillinger F, Torquato S. Modeling heterogeneous materials via two-point correlation functions: Basic principles. Physical Review E. 2007; 76:031110”, and is therefore not described in more detail for brevity.

The method 100 further includes, at step 106, using the link function ψ( ) to link the extracted microstructure image information Iᵢ (i.e., the centered two-point correlation function Xᵢ′(r)) to the random variable μᵢ, which effectively transforms the extracted microstructure image information Iᵢ into model distribution parameters. The functional linear regression (FLR) model is used as the link function ψ( ) in the illustrative method 100 herein. However, one or more other suitable models can be used as the link function ψ( ). Using the link function ψ( ) to link the extracted microstructure image information Iᵢ to the random variable μᵢ includes applying the link function ψ( ) (i.e., the FLR model) to the extracted microstructure image information Iᵢ (i.e., the centered two-point correlation function Xᵢ′(r)). The link function ψ( ) applied to the centered two-point correlation function Xᵢ′(r) as the FLR model is shown below as Equation (4), where β(r_{N}) represents the functional regression coefficients.

ψ(Iᵢ)=∫₀¹Xᵢ′(r)β(r)dr (4)

The functional regression coefficients β(r) of the FLR model and the extracted microstructure image information Iᵢ (i.e., the centered two-point correlation function Xᵢ′(r)) each consist of data with infinite dimensions. As such, the method 100 further includes, at step 108, reducing the dimensionality of the linked microstructure image information (i.e., Equation (4)) via projecting the extracted microstructure image information Iᵢ (i.e., the centered two-point correlation function Xᵢ′(r)) and/or one or more portions and/or variables of the link function ψ( ) (i.e., the functional regression coefficients β(r) of the FLR model) to one or more basis functions. The same basis functions bₖ(r), k=1, 2, . . . are chosen and used for the functional regression coefficients β(r) and the extracted microstructure image information Iᵢ (i.e., the centered two-point correlation function Xᵢ′(r)) herein for simplicity. Alternatively, different basis functions can be used for the functional regression coefficients β(r) and the extracted microstructure image information Iᵢ (i.e., the centered two-point correlation function Xᵢ′(r)). To reduce the dimensionality of functional data, the basis functions bₖ(r) are generally chosen as unified and orthogonal (i.e., bₖ(r) satisfies the following conditions: ∫₀¹bₗ(t)bₖ(t)dt=ξₗₖ, where ξₗₖ=1 if l=k, and ξₗₖ=0 if l≠k). As projected to the basis functions bₖ(r), the extracted microstructure image information Iᵢ (i.e., the centered two-point correlation function Xᵢ′(r)) can be represented as Σₖ₌₁^{+∞}ωᵢₖbₖ(r) (i.e., Xᵢ′(r)=Σₖ₌₁^{+∞}ωᵢₖbₖ(r)) and the functional regression coefficients β(r) can be represented as Σₖ₌₁^{+∞}κₖbₖ(r) (i.e., β(r)=Σₖ₌₁^{+∞}κₖbₖ(r)). The coefficients κₖ and the coefficients ωᵢₖ are calculated as shown in Equation (5) and Equation (6), respectively.

κₖ=∫₀¹β(r)bₖ(r)dr (5)

ωᵢₖ=∫₀¹Xᵢ′(r)bₖ(r)dr (6)

The number of basis functions bₖ(r) is generally infinite to represent the functional regression coefficients β(r) and the centered two-point correlation function Xᵢ′(r). In practice, only a truncated number of basis functions are selected to reduce data dimension. The functional regression coefficients β(r) and the centered two-point correlation function Xᵢ′(r) can therefore be represented as shown in Equation (7), where q is the truncated number of basis functions.

$$\{ \begin{matrix}β ( r ) = {\sum }_{k = 1}^{q} {κ}_{k} {b}_{k} ( r ) ; \\ {X}_{i}^{′} ( r ) = {\sum }_{k = 1}^{q} {ω}_{ik} {b}_{k} ( r ) ; i = 1 , 2 , … , n\end{matrix} \qquad ( 7 )$$

The truncated number of basis functions q is determined by the complexity of the functional coefficients β(r). The optimum value for the truncated number of basis functions q is utilized in Equation (7) and can be calculated via one or more known processes.

At step 110, the linked and dimensionally-reduced microstructure image information is incorporated into the nonlinear degradation model to obtain an updated and/or customized nonlinear degradation model for the material 12. The linked and dimensionally-reduced image information is incorporated into the nonlinear degradation model via substituting Equation (4) and Equation (7) into Equation (1) (i.e., the initial nonlinear degradation model) and manipulating substituted Equations (4) and (7) to obtain the customized nonlinear degradation model shown in Equation (8), where κ=(κ₁, κ₂, . . . , κ_{q})^{T} and to ωᵢ=(ωᵢ₁, ωᵢ₂, . . . , ω_{iq})^{T}. Due to the assumptions with respect to εᵢ detailed above, at least in Equation (8), μμᵢ⁻¹ follows a truncated normal distribution with parameters (μ₀+κ^{T}·ωᵢ,σ²) and μᵢ⁻¹ is bounded in the interval (0, +∞).

yᵢⱼ˜IG(μᵢΛ(tᵢⱼ),ηΛ²(tᵢⱼ))

μᵢ⁻¹=μ₀+κ^{T}·∫ᵢ+εᵢ (8)

The method 100 includes, at step 112, estimating parameters θ of the customized nonlinear degradation model of Equation (8) to obtain estimated parameters \hat{θ}. The parameters θ of the nonlinear degradation model are θ={η,μ₀,κ^{T},σ}. Accordingly, the estimated parameters \hat{θ} are θ={\hat{η}, \hat{μ}₀, \hat{κ}, \hat{σ}}.

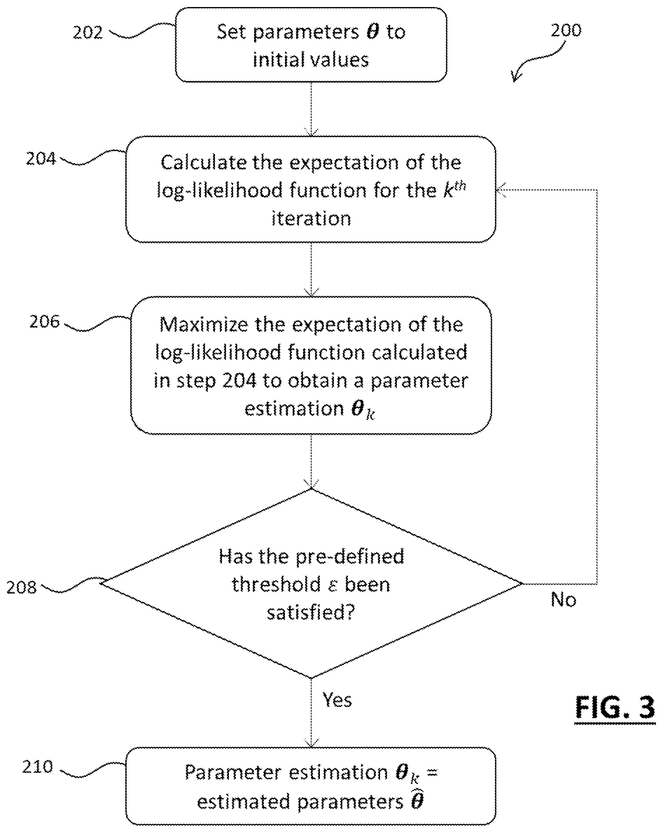

The estimated parameters \hat{θ} are estimated using an iterative EM method 200 in which the random variables μᵢ of the IG process, which cannot be obtained through observation or calculation, are treated as latent variables. The EM method 200 performed in step 112, which may also be referred to as an iterative expectation and maximization method, is depicted in FIG. 3. Alternatively, the estimated parameters \hat{θ} are estimated using an MLE method, though this method is not as efficient as the newly developed EM method 200 disclosed herein.

As shown in FIG. 3, at step 202, the EM method 200 includes setting initial values of the parameters θ as initial parameters θ₀=(μ₀₀, κ₀^{T}, σ₀, η₀).

Next, at step 204, the expectation of the log-likelihood function l_{D} (θ|Data, θₖ₋₁) (denoted as E(l_{D}(θ|Data,θₖ₋₁)) is calculated based on the expectation of μᵢₖ⁻¹ (denoted as E(μᵢₖ⁻¹)) and the expectation of μᵢₖ⁻² (denoted as E(μᵢₖ⁻²)) using Equation (9).

$$E ( {l}_{D} ( θ \vert Data , {θ}_{k - 1} ) ) = {\sum }_{i = 1}^{n} {\sum }_{j = 1}^{{m}_{i}} [ \frac{1}{2} ln {η}_{k} - \frac{{η}_{k}}{2} ( {β}_{i k} Δ {y}_{ij} - 2 {α}_{i k} Δ {t}_{ij} + \frac{Δ {t}_{i j}^{2}}{Δ {y}_{i j}} ) + ln Δ {t}_{ij} ] + {\sum }_{i = 1}^{n} [ ln ( {σ}_{k}^{- 1} ) - ln ( 1 - Φ ( - {σ}_{k}^{- 1} ( {μ}_{0 k} + {κ}_{k}^{T} \cdot {ω}_{i} ) ) ) - \frac{{σ}_{k}^{- 2} ( {β}_{i k} - 2 {α}_{i k} ( {μ}_{0 k} + {κ}_{k}^{T} \cdot {ω}_{i} ) + {( {μ}_{0 k} + {κ}_{k}^{T} \cdot {ω}_{i} )}^{2} )}{2} ] \qquad ( 9 )$$

yᵢ is the degradation path for the i^{th} sample.
yᵢⱼ is the degradation level as explained above.
yᵢ₀=0 and tᵢ₀=0.
Δyᵢⱼ are independent increments of the degradation level yᵢⱼ and can be calculated as follows Δyᵢⱼ=y_{i,j-1}.
Data={Δyᵢⱼ,Iᵢ, for i=1, 2, . . . , n and j=1, 2, . . . , mᵢ}.
tᵢⱼ=Λ(tᵢⱼ)−Λ(t_{i,j-1}), where the function Λ(t) are set as a parametric function (e.g., Λ(t)=log(t+1)) for simplicity, although other parametric functions and/or nonparametric functions can also be used.
ϕ is the probability density function of the standard normal distribution.
Φ is the cumulative distribution function of the standard normal distribution.

$${\tilde{σ}}_{i} = \sqrt{η {y}_{i {m}_{i}} + {σ}^{- 2}}$$

$${\tilde{μ}}_{0 i} = \frac{( ηΛ ( {t}_{i {m}_{i}} ) + {σ}^{- 2} ( {μ}_{0} + {κ}^{T} \cdot {ω}_{i} ) )}{{\tilde{σ}}_{i}^{2}}$$

$${α}_{i k} = E ( {μ}_{i k}^{- 1} ) = {\tilde{μ}}_{0 i k} + \frac{ϕ ( - {\tilde{σ}}_{i k} {\tilde{μ}}_{0 i k} )}{{\tilde{σ}}_{i k} [ 1 - Φ ( - {\tilde{σ}}_{i k} {\tilde{μ}}_{0 ik} ) ]}$$

$${β}_{i k} = E ( {μ}_{i k}^{- 2} ) = {\tilde{μ}}_{0 i k}^{2} + \frac{2 {\tilde{μ}}_{0 i k} ϕ ( - {\tilde{σ}}_{i k} {\tilde{μ}}_{0 i k} )}{{\tilde{σ}}_{i k} [ 1 - Φ ( - {\tilde{σ}}_{i k} {\tilde{μ}}_{0 i k} ) ]} + {\tilde{σ}}_{i k}^{- 2} ( 1 - \frac{{\tilde{σ}}_{i k} {\tilde{μ}}_{0 i k} ϕ ( - {\tilde{σ}}_{i k} {\tilde{μ}}_{0 i k} )}{1 - Φ ( - {\tilde{σ}}_{i k} {\tilde{μ}}_{0 i k} )} )$$

$${\tilde{σ}}_{i k} = \sqrt{{η}_{k} {y}_{i {m}_{i}} + {σ}_{k}^{- 2}}$$

$${\tilde{μ}}_{0 i k} = \frac{{η}_{k} Λ ( {t}_{i {m}_{i}} ) + {σ}_{k}^{- 2} ( {μ}_{0 k} + {κ}_{k}^{T} \cdot {ω}_{i} )}{{\tilde{σ}}_{i k}^{2}}$$

At step 206, the expectation of the log-likelihood function E (l_{D}(θ|Data,θₖ₋₁)) that was calculated in step 204 is maximized using Equation (10) to obtain a parameter estimation θₖ.

$${θ}_{k} = {arg max}_{θ ∈ {ℝ}^{q + 3}} E ( {l}_{D} ( θ \vert Data , {θ}_{k - 1} ) ) \qquad ( 10 )$$

The method 200 includes, at step 208, determining whether a pre-defined threshold ε has been satisfied via comparing Equation (11) to the pre-defined threshold ε.

(sup[E(l_{D}(θₖ|Data))]−sup[E(l_{D}(θₖ₋₁|Data))]) (11)

If Equation (11) is less than the pre-defined threshold ε at step 208, the method 200 proceeds to step 210 in which the estimated parameters \hat{θ} are determined to be and equated to the parameter estimation θₖ of the most recent/last iteration. If Equation (11) is equal to or greater than the pre-defined threshold ε at step 208, the method 200 returns to step 204 and another iteration is performed with the parameter estimation θₖ that was calculated in the previous iteration (e.g., the first iteration is executed with the initial parameters θ₀ to obtain a first parameter estimation θₖ₌₁, Equation (11) is greater than the pre-defined threshold ε, a second iteration is executed with the first parameter estimation θₖ₌₁ to obtain a second parameter estimation θₖ₌₂, . . . until Equation (11) is less than the pre-defined threshold ε).

Optionally, given the inherent uncertainty and randomness associated with microstructure and failures, the method 100 includes verifying that the estimated parameters \hat{θ} are accurate despite the inherent randomness of the variables at step 116. This may include (i) conducting a statistical inference for uncertainty quantification and/or (ii) calculating a Point-wise Confidence Band (PCB) of the functional coefficients β(r). When included in method 100, step 116 is performed after step 112 and prior to step 114.

Next, at step 114, one or more determinations and/or predications about the material 12 and/or object 10 are made and/or obtained using the customized nonlinear degradation model and the estimated parameters \hat{θ}. Step 114 may include incorporating the estimated parameters \hat{θ} into one or more equations and/or models (e.g., the customized nonlinear degradation model), such as via replacing one or more of the parameters θ={η, μ₀,κ^{T},σ} with the corresponding estimated parameters \hat{θ}={\hat{η}, \hat{μ}₀,\hat{κ},\hat{σ}}. Making one or more determinations and/or predications may include (i) predicting an expected failure time and/or an expected useful lifetime of the material 12 and/or object 10 (e.g., the material 12 and/or object 10 is most likely to fail at five years and, thus, has an expected useful lifetime of five years), (ii) predicting the failure probability of the material 12 and/or object 10 at a given time (e.g., at three years, there is a 30% chance that the material 12 and/or object 10 will have failed due to degradation and a 70% chance that it will not have failed due to degradation), and/or (iii) predicting an expected degradation level of the material 12 and/or object 10 at a given time (e.g., at three years, there is a 20% chance of that the material 12 and/or object 10 has experienced less than 10% degradation, a 5% chance of 10% degradation, and a 75% chance of greater than 10% degradation). The method 100 may include calculating and using at least one of (i) one or more probability density functions (PDFs), (ii) one or more cumulative distribution functions (CDFs), and (iii) a distribution of degradation level to make one or more of the aforementioned determinations and/or predications. For example, step 114 may include calculating a probability density function (PDF) of the change in degradation level over time (denoted as ƒ(ΔYᵢ)), a distribution of the degradation level ƒᵢ(y), a cumulative distribution function (CDF) of the predicted failure time distribution (denoted as Fᵢ(t), where i=1, 2, . . . , n), and/or a PDF of the predicted failure time distribution.

The PDF of the change in degradation level over time ƒ(ΔYᵢ) is calculated with Equation (12) where ΔYᵢ=(Δyᵢ₁, Δyᵢ₂, . . . Δyᵢₘ_{ᵢ}).

$$f ( Δ {Y}_{i} ) = \frac{1 - Φ ( - {\tilde{σ}}_{i} {\tilde{μ}}_{0 i} )}{1 - Φ ( - {σ}^{- 1} ( {μ}_{0} + {κ}^{T} \cdot {ω}_{i} )} \frac{{σ}^{- 1}}{{\tilde{σ}}_{i}} \cdot {\prod }_{j = 1}^{{m}_{i}} \sqrt{\frac{η Δ {t}_{ij}^{2}}{2 π Δ {y}_{ij}^{3}}} \cdot exp [ \frac{{\tilde{σ}}_{i}^{2} {\tilde{μ}}_{0 i}^{2} - {{σ}^{- 2} ( {μ}_{0} + {κ}^{T} \cdot {ω}_{i} )}^{2}}{2} - {\sum }_{j = 1}^{{m}_{i}} \frac{η Δ {t}_{ij}^{2}}{2 Δ {y}_{ij}} ] \qquad ( 12 )$$

Based on the PDF of the change in degradation level over time ƒ(ΔYᵢ), the distribution of the degradation level ƒᵢ(y) is calculated with Equation (13). An expected degradation level of the object and/or material at a given time may be predicted based on the calculated distribution of degradation level ƒᵢ(y).

$${f}_{i} ( y ) = \frac{1 - Φ ( - ( ηΛ ( t ) + {σ}^{- 2} ( {μ}_{0} + {κ}^{T} \cdot {ω}_{i} ) ) \times \sqrt{η y + {σ}^{- 2}} )}{1 - Φ ( - {σ}^{- 1} ( {μ}_{0} + {κ}^{T} \cdot {ω}_{i} ) )} \cdot \frac{{σ}^{- 1}}{\sqrt{η y + {σ}^{- 2}}} \cdot \sqrt{\frac{{ηΛ ( t )}^{2}}{2 π {y}^{3}}} . exp [ \frac{{( ηΛ ( t ) + {σ}^{- 2} ( {μ}_{0} + {κ}^{T} \cdot {ω}_{i} ) )}^{2}}{2 ( η y + {σ}^{- 2} )} - \frac{{( {μ}_{0} + {κ}^{T} \cdot {ω}_{i} )}^{2} {σ}^{- 2}}{2} - \frac{{ηΛ ( t )}^{2}}{2 y} ] \qquad ( 13 )$$

Based on the calculated PDF of the change in degradation level over time ƒ(ΔYᵢ) and the calculated distribution of the degradation level ƒᵢ(y), the CDF of the predicted failure time distribution Fᵢ(t) is calculated with Equation (14) where y denotes degradation level, t denotes time, D denotes a pre-defined failure threshold, and T_{D} denotes the failure time. That is, y_{t=T}_{_{D}}=D. The distribution of degradation level ƒᵢ(y) has a complex form, making it is difficult to obtain the closed-form integration of the distribution of degradation level ƒᵢ(y) in Equation (14). As such, a simulation method following the Trapezoidal rule may be utilized to calculate the integration of the distribution of degradation level ƒᵢ(y) in Equation (14). Based on the calculated CDF of the predicted failure time distribution Fᵢ(t), the failure probability of the material 12 and/or object 10 at a given time may be predicted.

Fᵢ(t)=P(T_{D}<t)=1−∫₀^{D}ƒᵢ(y)dy (14)

The PDF of the predicted failure time distribution may also be calculated (e.g., based at least partially on calculated PDF of the change in degradation level over time ƒ(ΔYᵢ)). An expected failure time, an expected useful lifetime, a confidence interval of failure time, and/or the useful lifetime of the material 12 and/or object 10 may be predicted based on the PDF of the predicted failure time distribution. For example, (i) the expected failure time and/or the expected useful lifetime may equated to the time value at which the distribution mean occurs (e.g., if the distribution mean is 5 years, than the expected failure time and/or the useful lifetime of the material 12 and/or object 10 may be predicted to be 5 years) and/or (ii) the confidence interval of failure time and/or the useful lifetime may equal to time values including the time value at which the distribution mean occurs (e.g., if the distribution mean is 5 years and the standard deviation is 1 year, the confidence interval of failure time and/or the useful lifetime of the material 12 and/or object 10 may be predicted to be 4-6 years).

The nonlinear degradation model and the degradation-based reliability analysis method 100 disclosed herein greatly outperform multiple existing models and methods, such as the linear degradation model described in “Si, W., Q. Yang, and X. Wu, Material degradation modeling and failure prediction using microstructure images. Technometrics, 2019. 61(2): p. 246-258” and the random drift IG model described in “Ye, Z.-S. and N. Chen, The inverse Gaussian process as a degradation model. Technometrics, 2014. 56(3): p. 302-311”. The aforementioned linear degradation model can only handle degradation processes having a linear trend, which significantly reduces its real-world applicability since most degradation processes follow nonlinear trends. Conversely, the nonlinear degradation model disclosed herein is not limited in this manner and can effectively model degradation processes that have a nonlinear trend. The disclosed nonlinear degradation model also outperformed the linear degradation model and the random drift IG model in terms of model fit and accuracy. The Akaike information criterion (AIC) value is generally used to compare different models for model fitting. A lower AIC value indicates a model fits the data set better. In conducted studies, the disclosed nonlinear degradation model had a lower AIC value than both the linear degradation model and the random drift IG model, indicating that it fit the test data set better than the linear degradation model and the random drift IG model. When the PDFs of the predicted failure time distributions for the three models were calculated and compared, the disclosed nonlinear degradation model had the lowest variance and a mean (which may be considered representative of the predicted useful lifetime) that was closest to the observed lifetime of the test object. This indicates that the disclosed nonlinear degradation model was more accurate than both the linear degradation model and the random drift IG model.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A degradation-based reliability analysis method, comprising:
capturing, via an imager, a microstructure image of a material;
transmitting the microstructure image to a computer;
extracting microstructure image information from the microstructure image to quantitatively characterize a microstructure of the material via processing the microstructure image with the computer;
incorporating, via the computer, the microstructure image information into a nonlinear degradation model; and
making, via the computer, at least one of a determination and a prediction regarding the material based on the nonlinear degradation model.

2. The method of claim 1, wherein making the at least one of the determination and the prediction regarding the material includes predicting at least one of an expected failure time and an expected useful lifetime of the material.

3. The method of claim 2, wherein:
making the at least one of the determination and the prediction regarding the material further includes calculating a probability density function of a predicted failure time distribution; and
the at least one of the expected failure time and the expected useful lifetime of the material is predicted based on the calculated probability density function.

4. The method of claim 1, wherein making the at least one of the determination and the prediction regarding the material further includes:
calculating a probability density function of a predicted failure time distribution; and
determining at least one of (i) a confidence interval of failure time of the material and (ii) a confidence interval of useful lifetime of the material based on the calculated probability density function of the predicted failure time distribution.

5. The method of claim 1, wherein making the at least one of the determination and the prediction regarding the material includes predicting a failure probability of the material at a given time.

6. The method of claim 5, wherein:
making the at least one of the determination and the prediction regarding the material further includes calculating a cumulative distribution function of a predicted failure time distribution; and
the failure probability of the material at the given time is predicted based on the calculated cumulative distribution function.

7. The method of claim 6, wherein:
calculating the cumulative distribution function of the predicted failure time distribution includes:
calculating a probability density function of a change in degradation level over time; and
calculating a distribution of the degradation level based on the calculated probability density function of the change in degradation level over time; and
the cumulative distribution function of the predicted failure time distribution is calculated based on the calculated distribution of the degradation level.

8. The method of claim 1, wherein making the at least one of the determination and the prediction regarding the material includes predicting an expected degradation level of the material at a given time.

9. The method of claim 8, wherein:
making the at least one of the determination and the prediction regarding the material further includes calculating a distribution of a degradation level of the material; and
the expected degradation level of the material at the given time is predicted based on the calculated distribution of the degradation level.

10. The method of claim 1, wherein extracting the microstructure image information from the microstructure image includes applying a two-point correlation function process to the microstructure image.

11. The method of claim 10, wherein applying the two-point correlation function process to the microstructure image includes calculating a centered two-point correlation function for at least one material phase in the microstructure image.

12. The method of claim 11, wherein the material is a dual-phase material including a first material phase and a second material phase.

13. The method of claim 1, further comprising, prior to incorporating the microstructure image information into the nonlinear degradation model, transforming the extracted microstructure image information into a plurality of model distribution parameters.

14. The method of claim 13, wherein transforming the microstructure image information into the plurality of model parameters includes linking the microstructure image information to a random variable using a link function.

15. The method of claim 14, wherein the link function is a functional linear regression model.

16. The method of claim 1, further comprising, prior to incorporating the microstructure image information into the nonlinear degradation model, reducing a dimensionality of the microstructure image information.

17. The method of claim 16, wherein reducing the dimensionality of the microstructure image information includes projecting the microstructure image information to at least one basis function.

18. The method of claim 1, further comprising estimating at least one parameter of the nonlinear degradation model.

19. The method of claim 18, wherein the at least one parameter of the nonlinear degradation model is estimated via performing an iterative expectation and maximization method.

20. The method of claim 1, wherein the nonlinear degradation model is represented as:
yᵢⱼ˜IG(μᵢΛ(tᵢⱼ),ηΛ²(tᵢⱼ)); and
μᵢ⁻¹=μ₀+ψ(Iᵢ)+εᵢ.
